(19) United States
(12) Patent Application Publication
(10) Pub. No.: US 2024/0430141 A1
(43) Pub. Date: Dec. 26, 2024

(54) SYSTEM FRAME NUMBER DETECTION

(71) Applicant: Nokia Technologies Oy, Espoo (FI)

(72) Inventors: Alessio MARCONE, München (DE); Elena PERALTA CALVO, Tampere (FI); Nhat-Quang NHAN, Nozay (FR); Cássio Barboza RIBEIRO, Espoo (FI)

(73) Assignee: Nokia Technologies Oy, Espoo (FI)

(21) Appl. No.: 18/705,111

(22) PCT Filed: Oct. 27, 2021
(86) PCT No.: PCT/EP2021/079895

§ 371 Date: Apr. 26, 2024

(51) Int. Cl. H04L 25/06; H04L 5/00

(52) U.S. Cl. CPC H04L 25/068; H04L 5/00

(57) ABSTRACT

Certain examples of the present disclosure relate to an apparatus (10), method (400) and computer program (14) for: receiving at least one first signal (501) comprising an indication of at least one bit of a first System Frame Number, SFN (302); determining, based at least in part on the received at least one first signal, at least one value of a reliability metric for the at least one bit of the first SFN; receiving at least one second signal (503) comprising an indication of at least one bit of a second SFN different than the first SFN; determining, based at least in part on the received at least one second signal and the determined at least one value of the reliability metric for the at least one bit of the first SFN, at least one value of a reliability metric for the at least one bit of the second SFN.

### TECHNOLOGICAL FIELD

Examples of the present disclosure relate to System Frame Number, SFN, detection. Some examples, though without prejudice to the foregoing, relate to improving the reliability of detection/reception of one or more bits of a SFN of a Physical Broadcast Channel, PBCH, of a Synchronization Signal Block, SSB, (referred to herein as SS/PBCH block) of a SS/PBCH block burst of a set of SS/PBCH block bursts.

### BACKGROUND

The SFN is carried by a PBCH payload of an SS/PBCH block. User Equipment, UE, uses the SFN at least for frame synchronization and PBCH descrambling.

In some circumstances it can be desirable to improve the reliability of detection and/or reception of one or more bits of an SFN. This can lead to improvements at least in a UE's frame synchronization and a UE's descrambling of a PBCH.

The listing or discussion of any prior-published document or any background in this specification should not necessarily be taken as an acknowledgement that the document or background is part of the state of the art or is common general knowledge. One or more aspects/examples of the present disclosure may or may not address one or more of the background issues.

### BRIEF SUMMARY

The scope of protection sought for various embodiments of the invention is set out by the claims.

According to various, but not necessarily all, examples of the disclosure there are provided examples as claimed in the appended claims. Any embodiments/examples and features described in this specification that do not fall under the scope of the independent claims are to be interpreted as examples useful for understanding various embodiments of the invention.

According to at least some examples of the disclosure there is provided an apparatus comprising means for:
receiving at least one first signal comprising an indication of at least one bit of a first System Frame Number, SFN;
determining, based at least in part on the received at least one first signal, at least one value of a reliability metric for the at least one bit of the first SFN;
receiving at least one second signal comprising an indication of at least one bit of a second SFN different than the first SFN;
determining, based at least in part on the received at least one second signal and the determined at least one value of the reliability metric for the at least one bit of the first SFN, at least one value of a reliability metric for the at least one bit of the second SFN.

According to various, but not necessarily all, examples of the disclosure there is provided a method comprising:
receiving at least one first signal comprising an indication of at least one bit of a first System Frame Number, SFN;
determining, based at least in part on the received at least one first signal, at least one value of a reliability metric for the at least one bit of the first SFN; receiving at least one second signal comprising an indication of at least one bit of a second SFN different than the first SFN;
determining, based at least in part on the received at least one second signal and the determined at least one value of the reliability metric for the at least one bit of the first SFN, at least one value of a reliability metric for the at least one bit of the second SFN.

According to various, but not necessarily all, examples of the disclosure there is provided a chipset comprising processing circuitry configured to perform the above-mentioned method.

According to various, but not necessarily all, examples of the disclosure there is provided a module, device and/or User Equipment, UE, comprising means for performing the above-mentioned method.

According to various, but not necessarily all, examples of the disclosure there is provided computer program instructions for causing an apparatus to perform:
receiving at least one first signal comprising an indication of at least one bit of a first System Frame Number, SFN;
determining, based at least in part on the received at least one first signal, at least one value of a reliability metric for the at least one bit of the first SFN;
receiving at least one second signal comprising an indication of at least one bit of a second SFN different than the first SFN;
determining, based at least in part on the received at least one second signal and the determined at least one value of the reliability metric for the at least one bit of the first SFN, at least one value of a reliability metric for the at least one bit of the second SFN.

According to various, but not necessarily all, examples of the disclosure there is provided an apparatus comprising:
at least one processor; and
at least one memory including computer program instructions;
the at least one memory and the computer program instructions configured to, with the at least one processor, cause the apparatus at least to perform:
   receiving at least one first signal comprising an indication of at least one bit of a first System Frame Number, SFN;
   determining, based at least in part on the received at least one first signal, at least one value of a reliability metric for the at least one bit of the first SFN; receiving at least one second signal comprising an indication of at least one bit of a second SFN different than the first SFN;
   determining, based at least in part on the received at least one second signal and the determined at least one value of the reliability metric for the at least one bit of the first SFN, at least one value of a reliability metric for the at least one bit of the second SFN.

According to various, but not necessarily all, examples of the disclosure there is provided a non-transitory computer readable medium encoded with instructions that, when performed by at least one processor, causes at least the following to be perform:
receiving at least one first signal comprising an indication of at least one bit of a first System Frame Number, SFN;
determining, based at least in part on the received at least one first signal, at least one value of a reliability metric for the at least one bit of the first SFN;
receiving at least one second signal comprising an indication of at least one bit of a second SFN different than the first SFN;
determining, based at least in part on the received at least one second signal and the determined at least one value of the reliability metric for the at least one bit of the first SFN, at least one value of a reliability metric for the at least one bit of the second SFN.

The following portion of this ‘Brief Summary’ section describes various features that can be features of any of the examples described in the foregoing portion of the ‘Brief Summary’ section. The description of a function should additionally be considered to also disclose any means suitable for performing that function.

In some but not necessarily all examples, the means are further configured to: determine a value of the at least one bit of the second SFN based at least in part on the determined at least one value of the reliability metric for the at least one bit of the second SFN.

In some but not necessarily all examples, the at least one first and/or the at least one second signal comprises at least one or a plurality selected from a group of:
at least one first and/or second transmission of time information;
at least one first and/or second transmission of one or more bits of the respective first and/or second SFN;
at least one first and/or second transmission of the respective at least one first and/or second SFN;
at least one first and/or second signal carried by a respective at least one first and/or second Physical Broadcast Channel, PBCH;
at least one first and/or second signal received in a respective at least one first and/or second radio frame;
at least one first and/or second signal carried by a respective at least one first and/or second SS/PBCH block;
at least one first and/or second signal carried by an SS/PBCH block of a respective at least one first and/or second SS/PBCH block burst; and
at least one first and/or second signal carried by an SS/PBCH block of a respective at least one first and/or second SS/PBCH block burst of a set of SS/PBCH block bursts transmitted over a pre-determined time interval.

In some but not necessarily all examples, the at least one bit of the first and/or second SFN is at least one selected from a group of:
one or more bits of a PBCH payload that are expected to vary over a pre-determined time interval;
an n^{th} bit of the respective first and/or second SFN;
some or all of the bits of the respective first and/or second SFN;
at least one Most Significant Bit, MSB, of the respective first and/or second SFN;
at least one Least Significant Bit, LSB, of the respective first and/or second SFN;
a second LSB of the respective first and/or second SFN; and a third LSB of the respective first and/or second SFN.

In some but not necessarily all examples, the reliability metric comprises a Log Likelihood Ratio, LLR.

In some but not necessarily all examples, determining the at least one value of a reliability metric for the at least one bit of the second SFN of the at least one second signal comprises: calculating at least one LLR for the at least one bit of the second SFN of the at least one second signal, and wherein calculating the at least one LLR for the at least one bit of the second SFN of the at least one second signal is based at least in part on a calculated LLR for the at least one bit of the first SFN of the at least one first signal.

In some but not necessarily all examples:
the at least one bit of the first SFN is: a second LSB of the first SFN and a third LSB of the first SFN; and
the at least one bit of the second SFN is: a second LSB of the second SFN and a third LSB of the second SFN.

In some but not necessarily all examples, determining the at least one value of a reliability metric for the at least one bit of the second SFN is based, at least in part, on a determination that the at least one second signal is received within a pre-determined time interval.

In some but not necessarily all examples, the pre-determined time interval comprises a time interval during which a majority of bits of a PBCH payload of a SS/PBCH block of a set of SS/PBCH block bursts is expected to remain constant.

In some but not necessarily all examples, the at least one first signal is received during a first radio frame, and wherein the at least one second signal is received during a second radio frame different to the first.

In some but not necessarily all examples, the first radio frame directly precedes the second radio frame.

In some but not necessarily all examples, there are one or more radio frames between the first radio frame and the second radio frame.

In some but not necessarily all examples, determining the at least one value of a reliability metric for the at least one bit of the first SFN comprises:
calculating:

$${L}_{{a}_{j}^{1}}^{{a}_{postertori}} = log ( \frac{P ( {y}_{j}^{1} \vert {a}_{j}^{1} = 0 )}{P ( {y}_{j}^{1} \vert {a}_{j}^{1} = 1 )} ) + {L}_{{a}_{j}^{1}}^{{a}_{priori}}$$

where:
a¹ⱼ is a bit of the at least one bit of the first SFN indicated in the at least one first signal in bit position j, wherein bit position j=0 represents the LSB of the first SFN;
Lₐ_{ⱼ}_{¹}^{a}^{ₚₒₛₜₑᵣᵢₒᵣᵢ} is an a-posteriori LLR for the bit aⱼ¹;
yⱼ¹ is the received at least one first signal at bit position j;
P(yⱼ¹|aⱼ¹=0) is a probability of the received at least one first signal, conditioned to the bit at bit position j being equal to 0;
P(yⱼ¹|aⱼ¹=1) is a probability of the received at least one first signal, conditioned to the bit at bit position j being equal to 1;
Lₐ_{ⱼ}_{¹}^{a}^{ₚᵣᵢₒᵣᵢ} is an a-priori LLR for a bit of the first SFN indicated in the at least one first signal in bit position j; and wherein Lₐ_{ⱼ}_{¹}^{a}^{ₚᵣᵢₒᵣᵢ}=0.

In some but not necessarily all examples, determining the at least one value of a reliability metric for the at least one bit of the second SFN comprises:
calculating:

$${L}_{{a}_{j}^{2}}^{{a}_{posteriori}} = log ( \frac{P ( {y}_{j}^{2} \vert {a}_{j}^{2} = 0 )}{P ( {y}_{j}^{2} \vert {a}_{j}^{2} = 1 )} ) + {L}_{{a}_{j}^{2}}^{{a}_{priori}}$$

where:
aⱼ² is a bit of the at least one bit of the second SFN indicated in the at least one second signal in bit position j, wherein bit position j=0 represents the LSB of the first SFN;
Lₐ_{ⱼ}_{²}^{a}^{ₚₒₛₜₑᵣᵢₒᵣᵢ} is an a-posteriori LLR for the bit aⱼ²;
yⱼ² is the received at least one second signal at bit position j;
P(yⱼ²|aⱼ²=0) is a probability of the received at least one second signal, conditioned to the bit at bit position j being equal to 0;
P(yⱼ²|aⱼ²=1) is a probability of the received at least one second signal, conditioned to the bit at bit position j being equal to 1; and
Lₐ_{ⱼ}_{²}^{a}^{ₚᵣᵢₒᵣᵢ} is an a-priori LLR for a bit of the second SFN indicated in the at least one second signal in bit position j.

In some but not necessarily all examples:
for j=1 and at least in the case there is one radio frame between the first radio frame, during which the at least one first signal is received, and the second radio frame, during which the at least one second signal is received;

Lₐ_{²}_{₁}^{a}^{ₚᵣᵢₒᵣᵢ}=−Lₐ_{¹}_{₁}^{a}^{ₚₒₛₜₑᵣᵢₒᵣᵢ}.

In some but not necessarily all examples:
for j=2 and at least in the case there is one radio frame between the first radio frame, during which the at least one first signal is received, and the second radio frame, during which the at least one second signal is received;

$${L}_{{a}_{2}^{2}}^{{a}_{priori}} = log ( \text{} \frac{P ( {a}_{2}^{2} = 0 )}{P ( {a}_{2}^{2} = 1 )} ) = \text{} log \text{} ( \text{} \frac{\begin{matrix}P ( {a}_{1}^{1} = 0 ) \cdot P ( {a}_{2}^{1} = 0 ) + \\ P ( {a}_{1}^{1} = 1 ) \cdot P ( {a}_{2}^{1} = 1 )\end{matrix}}{\begin{matrix}P ( {a}_{1}^{1} = 0 ) \cdot P ( {a}_{2}^{1} = 1 ) + \\ P ( {a}_{1}^{1} = 1 ) \cdot P ( {a}_{2}^{1} = 0 )\end{matrix}} ) = \text{} log ( \text{} \frac{1 + {e}^{( {L}_{{a}_{1}^{1}}^{{a}_{posteriori}} + {L}_{{a}_{1}^{1}}^{{a}_{posteriori}} )}}{{e}^{( {L}_{{a}_{1}^{1}}^{{a}_{posteriori}} )} + {e}^{( {L}_{{a}_{1}^{1}}^{{a}_{posteriori}} )}} )$$

In some but not necessarily all examples:
for any other j;

$${L}_{{a}_{j}^{2}}^{{a}_{priori}} = log ( \frac{P ( {a}_{j}^{2} = 0 )}{P ( {a}_{j}^{2} = 1 )} )$$

wherein P(a²ⱼ=0) and P(a²ⱼ=1) are related to P(a¹ₖ=0) and P(a¹ₖ=1), for 0≤k≤j, and
wherein

$$P ( {a}_{k}^{1} = 0 ) = \frac{{e}^{{L}_{{a}_{k}^{1}}^{{a}_{posteriori}}}}{1 + {e}^{{L}_{{a}_{k}^{1}}^{{a}_{posteriori}}}} and P ( {a}_{k}^{1} = 1 ) = \frac{1}{1 + {e}^{{L}_{{a}_{k}^{1}}^{{a}_{posteriori}}}}$$

While the above examples of the disclosure and optional features are described separately, it is to be understood that their provision in all possible combinations and permutations is contained within the disclosure. Also, it is to be understood that various examples of the disclosure can comprise any or all of the features described in respect of other examples of the disclosure, and vice versa.

### BRIEF DESCRIPTION OF THE DRAWINGS

Some examples will now be described with reference to the accompanying drawings in which:

FIG. 1 schematically illustrates an example of a radio telecommunications network suitable for use with examples of the present disclosure;

FIG. 2A schematically illustrates an example of a SS/PBCH block suitable for use with examples of the present disclosure;

FIG. 2B schematically illustrates an example of a set of SS/PBCH block bursts suitable for use with examples of the present disclosure;

FIG. 3 shows an example of a part of a PBCH payload suitable for use with examples of the present disclosure;

FIG. 4 schematically illustrates an example of method according to the present disclosure;

FIG. 5 is a signalling diagram schematically illustrating an example of signalling according to the present disclosure;

FIG. 6 schematically illustrates a further example of a set of SS/PBCH block bursts suitable for use with examples of the present disclosure;

FIG. 7 schematically illustrates an example of an apparatus according to the present disclosure; and

FIG. 8 schematically illustrates an example of a computer program according to the present disclosure.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

In the drawings (and description) a similar feature may be referenced by the same three-digit number. In the drawings (and description), an optional subscript to the three-digit number can be used to differentiate different instances of similar features. Therefore, a three-digit number without a subscript can be used as a generic reference and the three-digit number with a subscript can be used as a specific reference. A subscript can comprise a single digit that labels different instances. A subscript can comprise two digits including a first digit that labels a group of instances and a second digit that labels different instances in the group.

### Abbreviations/Definitions

LLR Log Likelihood Ratio
LSB Least Significative Bit(s)
MIB Master Information Block
NR New Radio
PBCH Physical Broadcast Channel
PSS Primary Synchronization Signal
SCS Subcarrier Spacing
SFN System Frame Number
SS/PBCH block Synchronization Signal/Physical Broadcast Channel block (may also be referred to as Synchronization Signal Block—SSB)
SSB Synchronization Signal Block (may also be referred to as Synchronization Signal/Physical Broadcast Channel block—SS/PBCH block)
SSS Secondary Synchronization Signal
TS Technical Specification
UE User Equipment

### DETAILED DESCRIPTION

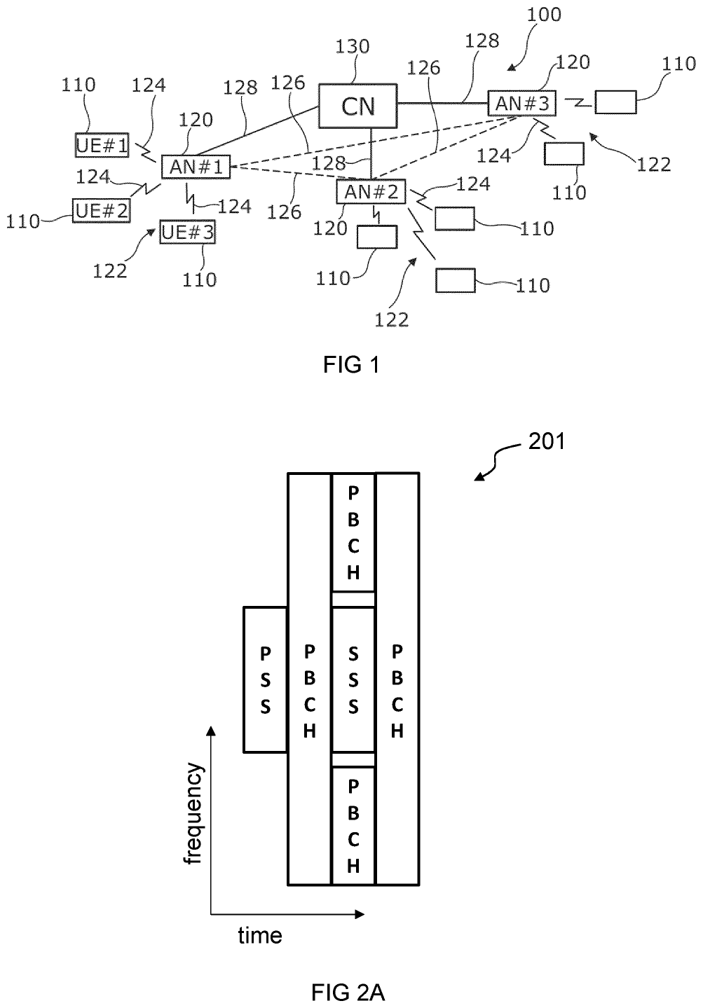

FIG. 1 schematically illustrates an example of a network 100 comprising a plurality of network nodes including terminal nodes 110 (also referred to as User Equipment, UE), access nodes 120 and one or more core nodes 130. The terminal nodes 110 and access nodes 120 communicate with each other. The access nodes 120 communicate with the one or more core nodes 130. The one or more core nodes 130 may, in some but not necessarily all examples, communicate with each other. The one or more access nodes 120 may, in some but not necessarily all examples, communicate with each other.

The network 100 is in this example a radio telecommunications network, i.e., a Radio Access Network, RAN, in which at least some of the terminal nodes 110 and access nodes 120 communicate with each other using transmission/reception of radio waves.

The RAN 100 may be a cellular network comprising a plurality of cells 122 each served by an access node 120. The access nodes 120 comprise cellular radio transceivers. The terminal nodes 110 comprise cellular radio transceivers.

In the particular example illustrated, the network 100 is a Next Generation (NG) or New Radio (NR) network. NR is the Third Generation Partnership Project (3GPP) name for 5G technology.

The interfaces between the terminal nodes 110 and the access nodes 120 are radio interfaces 124 (e.g., Uu interfaces). The interfaces between the access nodes 120 and one or more core nodes 130 are backhaul interfaces 128 (e.g., S1 and/or NG interfaces).

Depending on the exact deployment scenario, the access nodes 120 can be RAN nodes such as NG-RAN nodes. NG-RAN nodes may be gNodeBs (gNBs) that provide NR user plane and control plane protocol terminations towards the UE. NG-RAN nodes may be New Generation Evolved Universal Terrestrial Radio Access network (E-UTRAN) NodeBs (ng-eNBs) that provide E-UTRA user plane and control plane protocol terminations towards the UE. The gNBs and ng-eNBs may be interconnected with each other by means of Xn interfaces. The gNBs and ng-eNBs are also connected by means of NG interfaces to the 5G Core (5GC), more specifically to the AMF (Access and Mobility management Function) by means of the NG-C interface and to the UPF (User Plane Function) by means of the NG-U interface. The access nodes 120 may be interconnected with each other by means of Xn interfaces 126. The cellular network 100 could be configured to operate in licensed or unlicensed frequency bands, not least such as a 60 GHz unlicensed band where beamforming is mandatory in order to achieve required coverage.

The access nodes 120 can be deployed in a NR standalone operation/scenario. The access nodes 120 can be deployed in a NR non-standalone operation/scenario. The access nodes can be deployed in a Carrier Aggregation operation/scenario. The access nodes 120 can be deployed in a dual connectivity operation/scenario, i.e., Multi Radio Access Technology—Dual Connection (MR-DC), not least for example such as:
Evolved Universal Terrestrial Radio Access—New Radio Dual Connectivity (EUTRA-NR-DC, also referred to as EN-DC),
New Radio—Evolved Universal Terrestrial Radio Access Dual Connectivity (NR-EUTRA-DC, also referred to as NE-DC),
Next Generation Radio Access Network Evolved Universal Terrestrial Radio Access—New Radio Dual Connectivity (NG-RAN E-UTRA-NR Dual Connectivity, also referred to as NGEN-DC), or
New Radio Dual Connectivity (also referred to as NR-DC).

In such non-standalone/dual connectivity deployments, the access nodes 120 may be interconnected to each other by means of X2 or Xn interfaces, and connected to an Evolved Packet Core (EPC) by means of an S1 interface or to the 5GC by means of a NG interface.

The terminal nodes 110 are network elements in the network that terminate the user side of the radio link. They are devices allowing access to network services. The terminal nodes 110 may be referred to as User Equipment (UE), mobile terminals or mobile stations. The term ‘User Equipment’ may be used to designate mobile equipment comprising a smart card for authentication/encryption etc such as a subscriber identity module (SIM). In other examples, the term ‘User Equipment’ is used to designate mobile equipment comprising circuitry embedded as part of the user equipment for authentication/encryption such as software SIM.

The access nodes 120 are network elements in the network responsible for radio transmission and reception in one or more cells 122 to or from the terminal nodes 110. Such access nodes may also be referred to as a transmission reception points (TRP's) or base stations. The access nodes 120 are the network termination of a radio link. An access node 120 can be implemented as a single network equipment, or have a split architecture that is disaggregated/distributed over two or more RAN nodes, such as a central unit (CU), a distributed unit (DU), a remote radio head-end (RRH), using different functional-split architectures and different interfaces.

Where the access node 120 has a disaggregated (split) architecture, access node 120 can comprises one or more distributed units (gNB-DU) and a centralized unit (gNB-CU), not shown in FIG. 1. The gNB-CU is a logical node configured to host a Radio Resource Connection (RRC) layer and other layers of the access node 120. The gNB-CU controls the operation of one or more gNB-DUs. The gNB-DU is a logical node configured to host Radio Link Control (RLC) protocol layer, Medium Access Control (MAC) layer and Physical (PHY) layer of the access node 120. The gNB-DU communicates via a dedicated interface (F1) to the RRC layer hosted by the gNB-CU. One gNB-DU can support one or multiple cells 122, whereas one cell is supported by only one gNB-DU 220.

In the following description, an access node 120 will be referred to as gNB 120 and a terminal node 110 will be referred to as a UE 110.

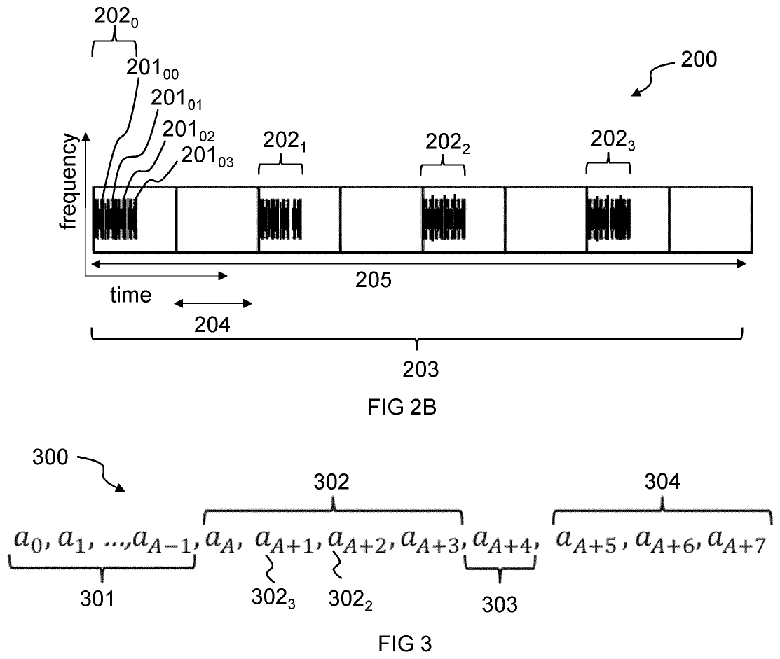

FIG. 2A schematically illustrates an example of a Synchronization Signal/Physical Broadcast Channel block, SS/PBCH block, which also may be referred to as a Synchronization Signal Block, SSB. SS/PBCH blocks are transmitted by a gNB to a UE in order to enable a UE to perform a synchronisation process, e.g., to synchronise with the gNB, and to acquire system and cell information.

As indicated in FIG. 2A, the SS/PBCH block 201 comprises a combination of a Synchronization Signal (namely a Primary Synchronization Signal, PSS, and a Secondary Synchronization Signal, SSS), together with a PBCH. The SS/PBCH block, e.g., as defined in [4, Technical Specification, TS, 38.211 V16.7.0 (2021 October)], is transmitted in a beamformed manner in New Radio, NR, Frequency Range 1, FR1, and Frequency Range 2, FR2.

In order to cover a whole cell space, multiple SS/PBCH block transmissions may need to occur in a so-called ‘SS/PBCH block burst’. SS/PBCH block bursts are confined within a half frame, i.e., a 5 ms window, e.g., as defined in [4.1, TS 38.213 V16.7.0 (2021 October)]. According to these specifications, candidate SS/PBCH blocks in a half frame are indexed in an ascending order in time from 0 to L̅ₘₐₓ−1 where L̅ₘₐₓ is determined according to the SS/PBCH block pattern for so-called Cases A to E. A maximum number of SS/PBCH blocks in one SS/PBCH block burst can be 4 or 8 for FR1, and 64 for FR2.

For a half frame with SS/PBCH blocks, first symbol indexes for each candidate SS/PBCH blocks are determined according to a SubCarrier Spacing, SCS, of the SS/PBCH blocks, where index n=0 corresponds to the first symbol of a first slot in a half-frame. For instance, a Case A time domain pattern of SS/PBCH block transmission is characterized by a SCS of 15 kHz. Case B and Case C are characterized by a SCS of 30 kHz. For each of Cases A, B and C, a SS/PBCH block burst in FR1 can have 4 or 8 consecutive SS/PBCH blocks within a half frame. Case D and Case E are characterized by a SCS of 120 kHz and 240 kHz, respectively; and an SSB burst in FR2 can have 64 consecutive SSBs within a half frame.

The time domain locations of the first symbol of each SS/PBCH block are defined, i.e., according to specifications in [4.1, TS 38.213 V16.7.0 (2021 October)] as follows for each Case:
Case A: {2,8}+14n wherein n={0,1} or n={0,1,2,3} for a frequency carrier below or above 3 GHz, respectively;
Case B: {4,8,16,20}+28n wherein n={0} or n={0,1} for a frequency carrier below or above 3 GHz, respectively;
Case C: {2,8}+14n wherein n={0,1} or n={0,1,2,3} for a frequency carrier below or above 3 GHz, respectively;
Case D: {4,8,16,20}+28n wherein n={0, 1, 2, 3, 5, 6, 7, 8, 10, 11, 12, 13, 15, 16, 17} for carrier frequencies within FR2; and
Case E: {8,12,16,20,32,36,40,44}+56n wherein n={0, 1, 2, 3, 5, 6,7,8} for carrier frequencies within FR2.

FIG. 2B schematically illustrates an example of a set 200 of SS/PBCH block bursts 202₀-202₃ transmitted over pre-determined time period—in this instance 8 consecutive radio frames, i.e., over an 80 ms time period (as indicated by the double headed arrow 204 representative of a radio frame duration, and the double headed arrow 205 representative of the SS/PBCH block burst set duration).

Each SS/PBCH block burst 202 of the set of SS/PBCH block bursts, is transmitted with a periodicity of 20 ms. Accordingly, in the 80 ms time interval, 4 SS/PBCH block bursts are transmitted, i.e., in this example, the set of SS/PBCH block bursts comprises 4 SS/PBCH block bursts 202₀-202₃. Each SS/PBCH block burst is transmitted within its own half frame/5 ms time window. Each SS/PBCH block burst 202 comprises a plurality of individual SS/PBCH blocks 201, in this instance 4 plurality of individual SS/PBCH blocks 201₀-201₃.

FIG. 3 illustrates a part 300 of a payload of a PBCH of an SS/PBCH block, in this instance, a PBCH payload, with a payload size of A bits, without a Cyclic Redundancy Check, CRC, attachment.

A PBCH payload carries cell information and time information. The PBCH can be generically split into Master Information Block, MIB, 301 and time information 302, 303 and 304. The MIB 301 provides a UE with parameters required for: monitoring a Physical Downlink Control Channel, PDCCH, and scheduling a Physical Downlink Shared Channel, PDSCH, that carries System Information Block type 1, SIB1. The time information part can be split into: Least Significant Bits, LSB, 302 of a System Frame Number, SFN (the Most Significant Bits, MSB, of the SFN are embedded in the MIB); a half frame bit 303; and a beam index 304. The SFN provides information that enables a UE to determine a system frame number for a frame to which a PBCH belongs, i.e., the SFN provides information indicative of/defining a system frame number for a frame to which a PBCH belongs.

With reference to FIG. 3, the two LSB SFN bits: a_{A+1} 302₃ (the third LSB of the SFN) and a_{A+2} 302₂ (the second LSB of the SFN) are expected to change at each SS/PBCH block, when considering an SS/PBCH block burst periodicity of 20 ms.

When deciding on a value of a bit represented in one or more received signals/transmissions, a reliability metric may be used that provides an indication of a level of correlation between a bit value detected from the received signal and a value of the bit that was transmitted (e.g., encoded/generated) in the signal. Such an indication may be indicative of a probability/likelihood that a received bit is a 0 or a 1 and may thereby provide a measurement of a reliability that a transmitted bit was a 0 or a 1. Such a reliability metric may be a Log Likelihood Ratio, LLR, for example an a-posteriori LLR.

As will be discussed in further detail below, examples of the present disclosure provide methods (and corresponding apparatuses and computer programs for effecting such methods) for improving a reliability of SFN bits by exploiting their correlation across different SS/PBCH blocks belonging to different SS/PBCH block bursts. The inventors of the present disclosure have appreciated that such SFN bits will change deterministically from one SS/PBCH block burst to another, and moreover that such bits will be related to each other through a binary sum operation. This deterministic change can be used at a UE receiver to improve a detection reliability of the SFN bits when multiple observations (multiple SS/PBCH blocks) at different frames are available.

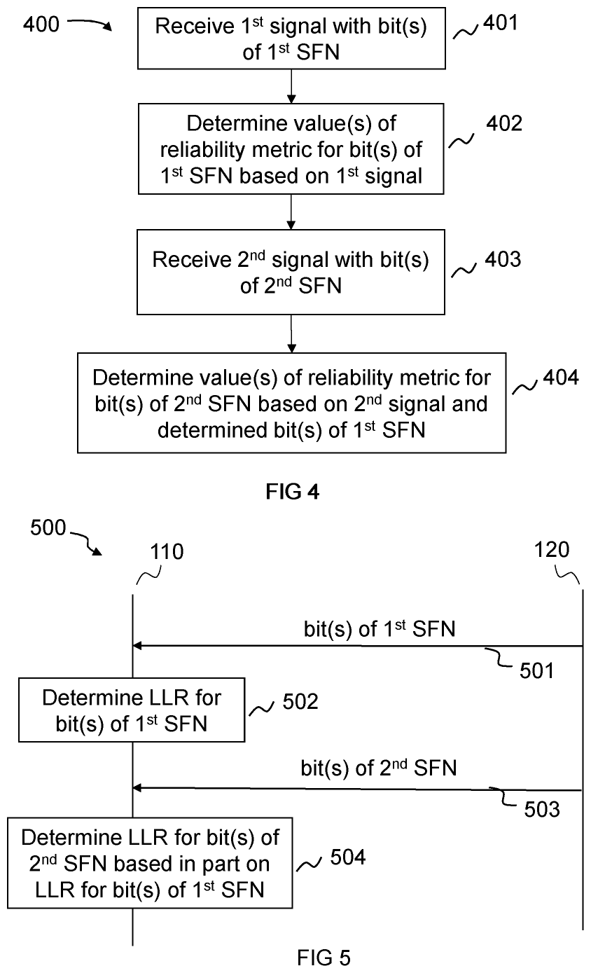

FIG. 4 schematically illustrates a flow chart of an example of a method 400 according to an example of the present disclosure. One or more of the features discussed in relation to FIG. 4 can be found in one or more of the other FIGs. During discussion of FIG. 4, reference will be made to other FIGs for the purposes of explanation.

The component blocks of FIG. 4 are functional and the functions described can be performed by a single physical entity (such as an apparatus 10 as described with reference to FIG. 7, which may be or comprised in a device, not least such as a UE 110). The functions described can also be implemented by a computer program (such as is described with reference to FIG. 8). The flowchart of FIG. 4 represents one possible scenario among others. The order of the blocks shown is not absolutely required, so in principle, the various blocks can be performed out of order. In certain examples one or more blocks can be performed in a different order or overlapping in time, in series or in parallel.

FIG. 5 is a signalling diagram illustrating signalling between a UE 110 and a gNB 120 (i.e., a Transmission Reception Point, TRP).

In block 401 of FIG. 4, at least one first signal is received, such as is shown with respect to transmission 501 of FIG. 5, wherein the at least one first signal comprises an indication of at least one bit (for instance, by way of a non-limiting example, the third and/or second LSB SFN bits: a_{A+1} 302₃ and/or a_{A+2} 302₂ of FIG. 3) of a first System Frame Number, SFN (e.g., 302 of FIG. 2).

In block 402, at least one value of a reliability metric for the at least one bit of the first SFN is determined based at least in part on the received first signal.

In block 403, at least one second signal is received, such as is shown with respect to transmission 503 of FIG. 5, wherein the at least one second signal comprises an indication of at least one bit of a second SFN (for instance, by way of a non-limiting example, the third and/or second LSB bits of a second SFN subsequent and different to the first SFN).

In block 403, at least one value of a reliability metric for the at least one bit of the second SFN is determined, wherein such determination is based at least in part on both:
the at least one received second signal, and
the determined at least one value of the reliability metric for at least one bit of the first SFN.

In some examples, at least one value of the at least one bit of the first SFN can be determined, based at least in part on the at least one value of the reliability metric for the at least one bit of the first SFN, such as is shown with respect to block 502 FIG. 5 wherein LLR(s) for the bit(s) of the first SFN are determined.

Likewise, at least one value of the at least one bit of the second SFN can be determined, based at least in part on the determined at least one value of the reliability metric for the at least one bit of the first SFN and the at least one value of the reliability metric for the at least one bit of the second SFN, such as is shown with respect to block 504 FIG. 5 wherein LLR(s) for the bit(s) of the first SFN are determined based at least in part on LLR for the bit(s) of 1st SFN.

In some examples, the at least one first and/or the at least one second signal comprises at least one selected from a group of:
at least one first and/or second transmission of time information (e.g., 302, of FIG. 3);
at least one first and/or second transmission of one or more bits of the respective first and/or second SFN (such bits may be carried, not least for example in a conventional PBCH of a conventional SS/PBCH block. In other examples, such bits may be provided via means other than a conventional PBCH of a conventional SS/PBCH block).
at least one first and/or second transmission of the respective at least one first and/or second SFN (e.g., 302 of FIG. 2);
at least one first and/or second signal carried by a respective at least one first and/or second Physical Broadcast Channel, PBCH;
at least one first and/or second signal received in a respective at least one first and/or second radio frame;
at least one first and/or second signal carried by a respective at least one first and/or second SS/PBCH block (e.g., an SS/PBCH block 201₀₀ of a first SS/PBCH block burst 202₀ and an SS/PBCH block 201₁₀ [not shown] of a second SS/PBCH block burst 202₁ of FIG. 2);
at least one first and/or second signal carried by an SS/PBCH block (e.g., 201 of FIG. 2) of a respective at least one first and/or second SS/PBCH block burst (e.g., 202₀ and 202₁ of FIG. 2); and
at least one first and/or second signal carried by an SS/PBCH block (e.g., 201 of FIG. 2) of a respective at least one first and/or second SS/PBCH block burst (e.g., 202₀ and 202₁ of FIG. 2) of a set of SS/PBCH block bursts (e.g., 200 of FIG. 2) transmitted over a pre-determined time interval (e.g., 203 of FIG. 2).

In some examples, the at least one first signal is received during a first radio frame, and the at least one second signal is received during a second radio frame different to the first. In some examples, the first radio frame directly precedes the second radio frame, i.e., the second radio frame directly follows the first radio frame such that they are directly sequential and adjacent one another in the time domain. In other examples, there are one or more intervening radio frames between the first radio frame and the second radio frame, i.e., the second radio frame does not directly follow the first radio frame such that they are not directly sequential or adjacent one another in the time domain.

In some examples, the at least one bit of the first and/or second SFN is at least one selected from a group of:
one or more bits of a PBCH payload that are expected to vary over a pre-determined time interval;
an n^{th} bit of the respective first and/or second SFN;
some or all of the bits of the respective first and/or second SFN;
at least one, some or all Most Significant Bits, MSBs, of the respective first and/or second SFN;
at least one, some or all Least Significant Bits, LSB, of the respective first and/or second SFN;
a second LSB of the respective first and/or second SFN (e.g., a_{A+2} 302₂ of FIG. 3); and
a third LSB of the respective first and/or second SFN (e.g., a_{A+1} 302₃ of FIG. 3).

In some examples, the reliability metric comprises at least one selected from a group of:
an indication of a level of correlation between a bit detected from the received signal and an equivalent bit that was transmitted in the signal;
an indication of a probability that a received bit is a 0 or a 1;
a measurement of a reliability that a transmitted bit was a 0 or a 1; and a Log Likelihood Ratio, LLR (e.g., of the at least one bit received in the first/second SFN of the first/second signal respectively).

In some examples, the determining the at least one value of a reliability metric for the at least one bit of the second SFN of the second signal comprises: calculating at least one LLR for the at least one bit of the second SFN of the second signal, and wherein calculating the at least one LLR for the at least one bit of the second SFN of the second signal is based at least in part on a calculated LLR for the at least one bit of the first SFN of the first signal.

In some examples, the at least one bit of the first SFN can comprise or consist of: a second LSB of the first SFN and a third LSB of the first SFN. Likewise, the at least one bit of the second SFN can comprise or consist of: a second LSB of the second SFN and a third LSB of the second SFN.

In some examples, the at least one bit of the first SFN can comprise or consist of: some or all of the LSB of the first SFN. Likewise, the at least one bit of the second SFN can comprise or consist of: some or all of the LSB of the second SFN.

In some examples, the at least one bit of the first SFN can comprise or consist of: some or all of the MSB of the first SFN. Likewise, the at least one bit of the second SFN can comprise or consist of: some or all of the MSB of the second SFN.

In some examples, the at least one bit of the first SFN can comprise or consist of: some or all of the bits of the first SFN. Likewise, the at least one bit of the second SFN can comprise or consist of: some or all of the bits of the second SFN.

There now follows further detail with regards to the determination of SFN bit values across different SS/PBCH block bursts and the calculation of LLRs for such bits which are used in determining/deciding the values of such bits represented by received signals transporting such bits.

The following described example focuses on an exemplary case for the two LSB SFN bits, namely the third and second LSB SFN bits: a_{A+1} 302₃ and a_{A+2} 302₂ within an 80 ms time period. However, it is to be appreciated that the principles underlying this particular exemplary case can be extended and generalized to the calculation of LLRs of other bits of a SFN (i.e., some or all of the bits of an SFN) for determining/deciding the values of such bits thereby increase the reliability of such bits of an SFN.

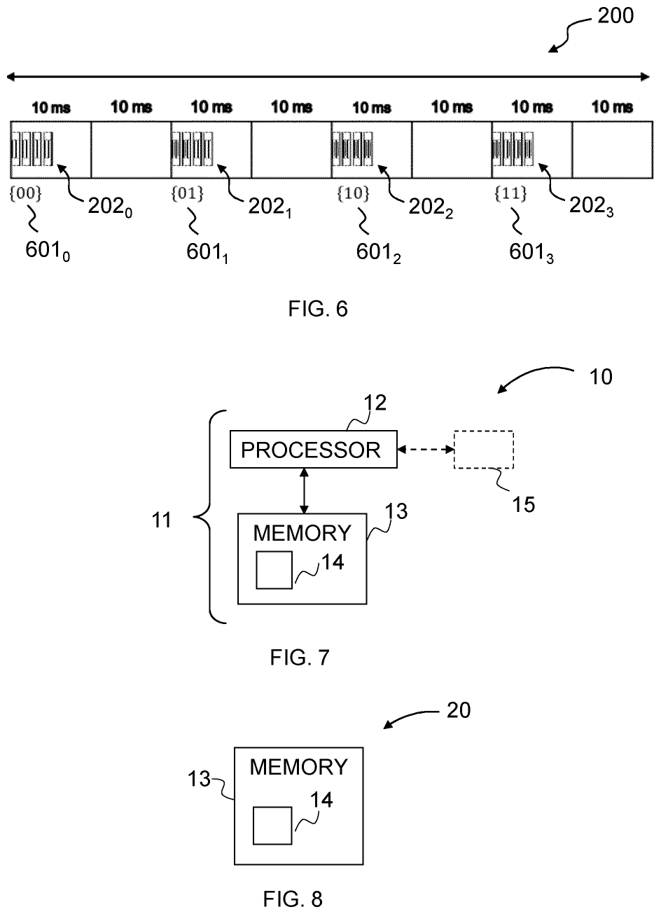

FIG. 6 schematically illustrates an example of a set 200 of SS/PBCH block bursts 202₀-202₃. In this non-limiting example, the SS/PBCH block bursts are transmitted/received within an 80 ms time period.

As with the set of SS/PBCH block bursts FIG. 2, in the set of SS/PBCH block bursts of FIG. 6, each SS/PBCH block burst 202 occurs with a periodicity of 20 ms and each SS/PBCH block burst 202 comprises 4 SS/PBCH blocks. It will be appreciated that, in other examples, there may be differing numbers of SS/PBCH blocks in an SS/PBCH block burst, e.g., 8 or 64.

Each SS/PBCH block of each SS/PBCH block burst 202 comprises a PBCH, which itself comprises an SFN, which itself comprises bits of the SFN including the third and second LSB SFN bits (i.e., 302₃ and 302₂ of FIG. 3). The third and second LSB SFN bits are referred to herein as “SFN bits” 302₃ and 302₂. In some examples, the SFN bits (or part thereof) may be carried by means other than an SFN of a PBCH, and instead the SFN bits (or part thereof) may be provided separately of the SFN of a PBCH.

The SFN bits change at each SS/PBCH block burst. The inventors of the present disclosure have appreciated that the SFN bits change at each SS/PBCH block burst following a binary sum operation.

If the SS/PBCH block bursts 202₀-202₃ with a periodicity of two frames (20 ms) are enumerated as i=0:3, and if the SFN bits at the i^{th} SS/PBCH block burst are enumerated as a′_{A+1} and a′_{A+2}, then the following relationship binds the SFN bits (i.e., the third and second LSB of the SFN 302₃ and 302₂) transmitted in two successive SS/PBCH block bursts (i.e., the i^{th} and i+1^{th} bursts):

$$[ {a}_{A + 1}^{i + 1} {a}_{A + 2}^{i + 1} ] = [ {a}_{A + 1}^{i} {a}_{A + 2}^{i} ] + [ 01 ] \qquad ( Formula 1 )$$

where the sum is a binary sum operation and not a modulo-2 (XOR) operation.

In the particular example FIG. 6, the bit values 601₀-601₃ for the SFN bits 302₃ and 302₂ for each SS/PBCH block burst 202₀-202₃ of the set of bursts in the 80 ms time period illustrated are as follows:
for the 1^{st} SS/PBCH block burst 202₀ (i=0): the SFN bits=[0 0] 601₀
for the 2^{nd} SS/PBCH block burst 202₁ (i=1): the SFN bits=[0 1] 60₁
for the 3^{rd} SS/PBCH block burst 202₂ (i=2): the SFN bits=[1 0] 601₂
for the 4^{th}/last SS/PBCH block burst 202₃ (i=3): the SFN bits=[1 1] 601₃

If one were to take the SFN bits 601₃ transmitted in the last SS/PBCH block burst 202₃ (i=3), i.e., {11}, these SFN bits can be derived by the SFN bits 601₂ in the second last SS/PBCH block burst (i=2) via the above-mentioned formula (1), namely:

$$[ {{a}^{3}}_{A + 1} {{a}^{3}}_{A + 2} ] = [ {{a}^{2}}_{A + 1} {{a}^{2}}_{A + 2} ] + [ 01 ] = [ 01 ] + [ 01 ] = [ 10 ]$$

Such relationship can finally be used to improve the detection reliability of the SFN bits as described in the following.

The a-priori probability of the bits [aⁱ_{A+1} aⁱ_{A+2}] can be represented as:

P(aⁱ_{A+1}) and

P(aⁱ_{A+2})

The LLRs, L, of the two bits, aⁱ_{A+1} aⁱ_{A+2} of the i^{th} SS/PBCH block, can be represented as:

Lₐ_{ⁱ}_{_{A+1}} and

Lₐ_{ⁱ}_{_{A+2}}

Based on the formulation (1) above, the following relationships (1.1) can be defined between the a-priori probabilities of the bits aⁱ_{A+1} aⁱ_{A+2} at burst i and i+1:

$$P ( {{a}^{i + 1}}_{A + 2} = 0 ) = P ( {{a}^{i}}_{A + 2} = 1 ) \qquad ( Formulas 1.1 )$$

$$P ( {{a}^{i + 1}}_{A + 2} = 1 ) = P ( {{a}^{i}}_{A + 2} = 0 )$$

$$P ( {{a}^{i + 1}}_{A + 1} = 0 ) = P ( {{a}^{i}}_{A + 1} = 0 ) \cdot P ( {{a}^{i}}_{A + 2} = 0 ) + P ( {{a}^{i}}_{A + 1} = 1 ) \cdot P ( {{a}^{i}}_{A + 2} = 1 )$$

$$P ( {{a}^{i + 1}}_{A + 1} = 1 ) = P ( {{a}^{i}}_{A + 1} = 0 ) \cdot P ( {{a}^{i}}_{A + 2} = 1 ) + P ( {{a}^{i}}_{a + 1} = 1 ) \cdot P ( {{a}^{i}}_{a + 2} = 0 )$$

An a-priori LLR may provide a measure of the reliability of a transmitted bit being equal to 0 or 1 in the absence of any other observation in the same transmission window.

An a-priori LLR input for the third and second LSBs 302₃ and 302₂ of the SFN can be defined as:

$${L}_{{{a}^{i + 1}}_{A + k}}^{{a}_{priori}} = log ( \frac{P ( {{a}^{i + 1}}_{A + k} = 0 )}{P ( {{a}^{i + 1}}_{A + k} = 1 )} ) for k = 1 , 2$$

wherein:
for k=1, bit position A+k=A+1 which represents the third LSB of the SFN 302₃,
for k=2, bit position A+k=A+2 which represents the second LSB of the SFN 302₂

An a-posteriori LLR is a calculation that a receiver usually performs when deciding/determining a bit value represented in a received signal. The a-posteriori LLR is a logarithm of the ratio between the probabilities of a transmitted bit being equal to either 0 or 1, conditioned to a received signal y. The a-posteriori LLR may provide a measure of the reliability of the transmitted bit being equal to 0 or 1 conditioned to the observation of the received signal y in the same transmission window.

An a-posteriori LLR can be defined as:

$${L}_{{{a}^{i + 1}}_{A + k}}^{{a}_{posteriori}} = log ( \frac{P ( {{a}^{i + 1}}_{A + k} = 0 \vert {y}_{A + k}^{i + 1} )}{P ( {{a}^{i + 1}}_{A + k} = 1 \vert {y}_{A + k}^{i + 1} )} ) = log ( \frac{P ( {y}_{A + k}^{i + 1} \vert {{a}^{i + 1}}_{A + k} = 0 )}{P ( {y}_{A + k}^{i + 1} \vert {{a}^{i + 1}}_{A + k} = 1 )} ) + {L}_{{{a}^{i + 1}}_{A + k}}^{{a}_{priori}} \qquad ( 2 )$$

where:
y_{A+k}ⁱ⁺¹ is the received signal in bit position A+k, for k=1,2, at SS/PBCH block burst i+1;
P(y_{A+k}|aⁱ_{A+k}=0)=probability of the received signal, conditioned to the bit at bit position A+k, being equal to 0;
P(y_{A+k}|aⁱ_{A+k}=1)=probability of the received signal, conditioned to the bit at bit position A+k, being equal to 1;
Lₐ_{ⁱ⁺¹}_{_{A+k}}^{a}^{ₚᵣᵢₒᵣᵢ}=a-priori LLR for a bit of the SFN in bit position A+k at SS/PBCH block burst i+1; wherein Lₐ_{ⁱ⁺¹}_{_{A+k}}^{a}^{ₚᵣᵢₒᵣᵢ} is usually equal to 0 since the a-priori probability of the transmitted bits is assumed to be 0.5 since, usually, transmitted bits at different times are independent

However, the inventors of the present disclosure have appreciated that, in this example, the 3^{rd} and 2^{nd} LSB of an SFN of an i+1^{th} SS/PBCH block burst are not independent to the 3^{rd} and 2^{nd} LSB of an SFN of an i^{th} SS/PBCH block burst, but that such LSBs are deterministically dependent on one another, namely via formulation (1) above. Accordingly, Lₐ_{ⁱ⁺¹}_{_{A+k}}^{a}^{ₚᵣᵢₒᵣᵢ}≠0, and instead, since the transmitted SFN bits at SS/PBCH block burst i and i+1 are correlated by the relationships described above (formulas (1) and (1.1)), the Lₐ_{ⁱ⁺¹}_{_{A+k}}^{a}^{ₚᵣᵢₒᵣᵢ} can be defined as:

$${L}_{{{a}^{i + 1}}_{A + 2}}^{{a}_{priori}} = log ( \frac{P ( {{a}^{i + 1}}_{A + 2} = 0 )}{P ( {{a}^{i + 1}}_{A + 2} = 1 )} ) = log ( \frac{P ( {{a}^{i}}_{A + 2} = 1 )}{P ( {{a}^{i}}_{A + 2} = 0 )} ) = log ( \frac{\frac{\frac{1}{1 + {e}^{{L}_{{{a}^{i}}_{A + 2}}^{{a}_{posteriori}}}}}{{e}^{{L}_{{{a}^{i}}_{A + 2}}^{{a}_{posteriori}}}}}{1 + {e}^{{L}_{{{a}^{i}}_{A + 2}}^{{a}_{posteriori}}}} ) = - {L}_{{{a}^{i}}_{A + 2}}^{{a}_{posteriori}} \qquad ( 3 )$$

where:

$$P ( {{a}^{i}}_{A + 2} = 0 ) = \frac{{e}^{{L}_{{{a}^{i}}_{A + 2}}^{{a}_{posteriori}}}}{1 + {e}^{{L}_{{{a}^{i}}_{A + 2}}^{{a}_{posteriori}}}} and$$

$$P ( {{a}^{i}}_{A + 2} = 1 ) = \frac{1}{1 + {e}^{{L}_{{{a}^{i}}_{A + 2}}^{{a}_{posteriori}}}}$$

and where Lₐ_{ⁱ}_{_{A+2}}^{a}^{_{posteriori is the a-posteriori LLR calculated at SS/PBCH block burst i assuming L}}ₐ_{ⁱ}_{_{A+1}}^{a}^{ₚᵣᵢₒᵣᵢ}=0 in this example description.

In a similar way, and again using the formulation in (1.1), the Lₐ_{ⁱ⁺¹}_{_{A+1}}^{a}^{ₚᵣᵢₒᵣᵢ} can be found and related to the L^{a}^{ₚₒₛₜₑᵣᵢₒᵣᵢ} of aⁱ_{A+1} and aⁱ_{A+2} which are available at UE receiver from the detection of SS/PBCH block burst i, namely:

$${L}_{{{a}^{i + 1}}_{A + 1}}^{{a}_{priori}} = log ( \frac{P ( {{a}^{i + 1}}_{A + 1} = 0 )}{P ( {{a}^{i + 1}}_{A + 1} = 1 )} ) = log ( \frac{P ( {{a}^{i}}_{A + 1} = 0 ) \cdot P ( {{a}^{i}}_{A + 2} = 0 ) + P ( {{a}^{i}}_{A + 1} = 1 ) \cdot P ( {{a}^{i}}_{A + 2} = 1 )}{P ( {{a}^{i}}_{A + 1} = 0 ) \cdot P ( {{a}^{i}}_{A + 2} = 1 ) + P ( {{a}^{i}}_{A + 1} = 1 ) \cdot P ( {{a}^{i}}_{A + 2} = 0 )} ) = log ( \frac{1 + {e}^{( {L}_{{{a}^{i}}_{A + 1}}^{{a}_{posteriori}} + {L}_{{{a}^{i}}_{A + 2}}^{{a}_{posteriori}} )}}{{e}^{( {L}_{{{a}^{i}}_{A + 1}}^{{a}_{posteriori}} )} + {e}^{( {L}_{{{a}^{i}}_{A + 2}}^{{a}_{posteriori}} )}} ) \qquad ( 4 )$$

Once these two a-priori LLR (3) and (4) have been determined/calculated, they can be input into the formula (2) above to derive the a-posteriori LLR at i+1 (Lₐ_{ⁱ⁺¹}_{A+k}^{a}^{ₚₒₛₜₑᵣᵢₒᵣᵢ}) for the third and second LSBs of the SFNs of the PBCHs of the SS/PBCH blocks of the i+1^{th} SS/PBCH block burst.

Advantageously, this increases the reliability of the computed a-posteriori LLRs for both the 3^{rd} and 2^{nd} SFN LSBs aⁱ⁺¹_{A+1} and aⁱ⁺¹_{A+2}.

The above procedure can be iterated a number of times (e.g., for differing SS/PBCH block of differing SS/PBCH block bursts), until a desired reliability of the SFN bits is achieved.

As an exemplary application, let us consider two consecutive SS/PBCH block bursts (i and i+1) with a periodicity of two frames (20 ms) that carry the 3^{rd} and 2^{nd} LSB SFN bits [0 1] (for the i^{th} burst) and [1 0] (for the i+1^{th} burst).

Let us also assume that the two bits are Binary Phase Shift Keying, BPSK, modulated (i.e., 0->+1, and 1->−1) and affected by Additive White Gaussian Noise, AWGN, channel. The transmitted signal x at burst i will be:

{x_{A+1}ⁱ,x_{A+2}ⁱ}={+1,−1}

and the transmitted signal at burst i+1 will be:

{x_{A+1}ⁱ⁺¹,x_{A+2}ⁱ⁺¹}={−1,+1}.

Let us yet further assume that the received signal y (where y=x+AWGN_noise) at burst i gives an a-posteriori LLR per bit equal to:

Lₐ_{ⁱ}_{_{A+1}}^{a}^{ₚₒₛₜₑᵣᵢₒᵣᵢ}=+10 and

Lₐ_{ⁱ}_{_{A+1}}^{a}^{ₚₒₛₜₑᵣᵢₒᵣᵢ}=−3

It is noted that the a-posteriori LLR for the received signal y at burst i can be defined as:

$${L}_{{{a}^{i}}_{A + j}}^{{a}_{posteriori}} = log ( \frac{P ( {y}_{A + k}^{i} \vert {{a}^{i}}_{A + k} = 0 )}{P ( {y}_{A + k}^{i} \vert {{a}^{i}}_{A + k} = 1 )} )$$

where: y=x+n with n corresponding to the AWGN, and Lₐ_{ⁱ}_{_{A+k}}^{a}^{ₚᵣᵢₒᵣᵢ}=0 since no information on the statistics of the transmitted bits is available at time i (burst i−1 was not detected).

Finally, let us assume that the received signal y at burst i+1 gives a “conventional” a-posteriori LLR per bit equal to:

Lₐ_{ⁱ⁺¹}_{_{A+1}}^{a}^{ₚₒₛₜₑᵣᵢₒᵣᵢ}=+2 and

Lₐ_{ⁱ⁺¹}_{_{A+2}}^{a}^{ₚₒₛₜₑᵣᵢₒᵣᵢ}=+3

Wherein the “conventional” a-posteriori LLR corresponds to one that does not consider Lₐ_{ⁱ⁺¹}_{_{A+k}}^{a}^{ₚᵣᵢₒᵣᵢ} and merely deems Lₐ_{ⁱ⁺¹}_{_{A+k}}^{a}^{ₚᵣᵢₒᵣᵢ}=0, i.e., it simply considers:

$${L}_{{{a}^{i + 1}}_{A + k}}^{{a}_{posteriori}} = log ( \frac{P ( {y}_{A + k}^{i + 1} \vert {{a}^{i + 1}}_{A + k} = 0 )}{P ( {y}_{A + k}^{i + 1} \vert {a}^{i} + {1}_{A + k} = 1 )} )$$

since no information on the statistics of the transmitted bits is available at time i+1.

It is noted that, in such a scenario, a decision on such Lₐ_{ⁱ⁺¹}_{_{A+1}}^{a}^{ₚₒₛₜₑᵣᵢₒᵣᵢ} and Lₐ_{ⁱ⁺¹}_{_{A+2}}^{a}^{ₚₒₛₜₑᵣᵢₒᵣᵢ} values +2 and +3 would lead to a wrong decision on the transmitted 3^{rd} and 2^{nd} LSB of the SFN, namely [0 0] instead of [1 0].

However, if one were to apply the teaching of the present disclosure to this exemplary scenario, one would firstly compute:

$${L}_{{{a}^{i + 1}}_{A + 2}}^{{a}_{priori}} = - {L}_{{{a}^{i}}_{A + 2}}^{{a}_{posteriori}} = + 3 and$$

$${L}_{{{a}^{i + 1}}_{A + 1}}^{{a}_{priori}} = log ( \frac{1 + {e}^{( {L}_{{{a}^{i}}_{A + 1}}^{{a}_{posteriori}} + {L}_{{{a}^{i}}_{A + 2}}^{{a}_{posteriori}} )}}{{e}^{( {L}_{{{a}^{i}}_{A + 1}}^{{a}_{posteriori}} )} + {e}^{( {L}_{{{a}^{i}}_{A + 2}}^{{a}_{posteriori}} )}} ) = log ( \frac{1 + {e}^{+ 7}}{{e}^{10} + {e}^{- 3}} ) = - 3$$

Entering these a-priori LLR values into the formula (2) for the a-posteriori LLR at burst i+1 and re-computing the a-posteriori LLR for each bit, one would get:

Lₐ_{ⁱ⁺¹}_{_{A+1}}^{a}^{ₚₒₛₜₑᵣᵢₒᵣᵢ}=+2+Lₐ_{ⁱ⁺¹}_{_{A+1}}^{a}^{ₚᵣᵢₒᵣᵢ}+=+2+(−3)=−1 and

Lₐ_{ⁱ⁺¹}_{_{A+2}}^{a}^{ₚₒₛₜₑᵣᵢₒᵣᵢ₌₊}3+Lₐ_{ⁱ⁺¹}_{_{A+2}}^{a}^{ₚᵣᵢₒᵣᵢ}=+3+(+3)=+6.

Such a-posteriori LLRs would finally lead to a correct decision on the transmitted bits [1 0] at burst i+1.

It will be understood that each block and combinations of blocks illustrated in FIGS. 4 and 5, as well as the further functions described above, can be implemented by various means, such as hardware, firmware, and/or software including one or more computer program instructions. For example, one or more of the functions described above can be performed by a duly configured apparatus (such as an apparatus, or UE, comprising means for performing the below described functions). One or more of the functions described below can be embodied by a duly configured computer program (such as a computer program comprising computer program instructions which embody the functions described below and which can be stored by a memory storage device and performed by a processor).

As will be appreciated, any such computer program instructions can be loaded onto a computer or other programmable apparatus (i.e., hardware) to produce a machine, such that the instructions when performed on the programmable apparatus create means for implementing the functions specified in the blocks. These computer program instructions can also be stored in a computer-readable medium that can direct a programmable apparatus to function in a particular manner, such that the instructions stored in the computer-readable memory produce an article of manufacture including instruction means which implement the function specified in the blocks. The computer program instructions can also be loaded onto a programmable apparatus to cause a series of operational actions to be performed on the programmable apparatus to produce a computer-implemented process such that the instructions which are performed on the programmable apparatus provide actions for implementing the functions specified in the blocks.

Various, but not necessarily all, examples of the present disclosure can take the form of a method, an apparatus or a computer program. Accordingly, various, but not necessarily all, examples can be implemented in hardware, software or a combination of hardware and software.

Various, but not necessarily all, examples of the present disclosure are described using flowchart illustrations and schematic block diagrams. It will be understood that each block (of the flowchart illustrations and block diagrams), and combinations of blocks, can be implemented by computer program instructions of a computer program. These program instructions can be provided to one or more processor(s), processing circuitry or controller(s) such that the instructions which execute on the same create means for causing implementing the functions specified in the block or blocks, i.e., such that the method can be computer implemented. The computer program instructions can be executed by the processor(s) to cause a series of operational steps/actions to be performed by the processor(s) to produce a computer implemented process such that the instructions which execute on the processor(s) provide steps for implementing the functions specified in the block or blocks.

Accordingly, the blocks support: combinations of means for performing the specified functions; combinations of actions for performing the specified functions; and computer program instructions/algorithm for performing the specified functions. It will also be understood that each block, and combinations of blocks, can be implemented by special purpose hardware-based systems which perform the specified functions or actions, or combinations of special purpose hardware and computer program instructions.

Various, but not necessarily all, examples of the present disclosure provide both a method and corresponding apparatus comprising various modules, means or circuitry that provide the functionality for performing/applying the actions of the method. The modules, means or circuitry can be implemented as hardware, or can be implemented as software or firmware to be performed by a computer processor. In the case of firmware or software, examples of the present disclosure can be provided as a computer program product including a computer readable storage structure embodying computer program instructions (i.e., the software or firmware) thereon for performing by the computer processor.

FIG. 7 schematically illustrates a block diagram of an apparatus 10 for performing the methods, processes, procedures and signalling described in the present disclosure and illustrated in FIGS. 4 and 5. In this regard the apparatus can perform the role of a UE 110.

The apparatus comprises a controller 11, which could be provided within a device such as a UE 110.

The controller 11 can be embodied by a computing device, not least such as those mentioned above. In some, but not necessarily all examples, the apparatus can be embodied as a chip, chip set or module, i.e., for use in any of the foregoing. As used here ‘module’ refers to a unit or apparatus that excludes certain parts/components that would be added by an end manufacturer or a user.

Implementation of the controller 11 can be as controller circuitry. The controller 11 can be implemented in hardware alone, have certain aspects in software including firmware alone or can be a combination of hardware and software (including firmware).

The controller 11 can be implemented using instructions that enable hardware functionality, for example, by using executable instructions of a computer program 14 in a general-purpose or special-purpose processor 12 that can be stored on a computer readable storage medium 13, for example memory, or disk etc, to be executed by such a processor 12.

The processor 12 is configured to read from and write to the memory 13. The processor 12 can also comprise an output interface via which data and/or commands are output by the processor 12 and an input interface via which data and/or commands are input to the processor 12. The apparatus can be coupled to or comprise one or more other components 15 (not least for example: a radio transceiver, sensors, input/output user interface elements and/or other modules/devices/components for inputting and outputting data/commands).

The memory 13 stores a computer program 14 comprising computer program instructions (computer program code) that controls the operation of the apparatus 10 when loaded into the processor 12. The computer program instructions, of the computer program 14, provide the logic and routines that enables the apparatus to perform the methods, processes and procedures described in the present disclosure and illustrated in the FIGs. The processor 12 by reading the memory 13 is able to load and execute the computer program 14.

Although the memory 13 is illustrated as a single component/circuitry it can be implemented as one or more separate components/circuitry some or all of which can be integrated/removable and/or can provide permanent/semi-permanent/dynamic/cached storage.

Although the processor 12 is illustrated as a single component/circuitry it can be implemented as one or more separate components/circuitry some or all of which can be integrated/removable. The processor 12 can be a single core or multi-core processor.

The apparatus can include one or more components for effecting the methods, processes and procedures described in the present disclosure and illustrated in the FIGs. It is contemplated that the functions of these components can be combined in one or more components or performed by other components of equivalent functionality. The description of a function should additionally be considered to also disclose any means suitable for performing that function. Where a structural feature has been described, it can be replaced by means for performing one or more of the functions of the structural feature whether that function or those functions are explicitly or implicitly described.

Although examples of the apparatus have been described above in terms of comprising various components, it should be understood that the components can be embodied as or otherwise controlled by a corresponding controller or circuitry such as one or more processing elements or processors of the apparatus. In this regard, each of the components described above can be one or more of any device, means or circuitry embodied in hardware, software or a combination of hardware and software that is configured to perform the corresponding functions of the respective components as described above.

The apparatus can, for example, be a UE, a client device, a mobile cellular telephone, a wireless communications device, a hand-portable electronic device, a location/position tag, a hyper tag etc. The apparatus can be embodied by a computing device, not least such as those mentioned above. However, in some examples, the apparatus can be embodied as a chip, chip set or module, i.e., for use in any of the foregoing.

In one example, the apparatus is embodied on a hand held portable electronic device, such as a mobile telephone, wearable computing device or personal digital assistant, that can additionally provide one or more audio/text/video communication functions (for example tele-communication, video-communication, and/or text transmission (Short Message Service (SMS)/Multimedia Message Service (MMS)/emailing) functions), interactive/non-interactive viewing functions (for example web-browsing, navigation, TV/program viewing functions), music recording/playing functions (for example Moving Picture Experts Group-1 Audio Layer 3 (MP3) or other format and/or (frequency modulation/amplitude modulation) radio broadcast recording/playing), downloading/sending of data functions, image capture function (for example using a (for example in-built) digital camera), and gaming functions.

In examples the apparatus comprises:
at least one processor 12; and
at least one memory 13 including computer program code
the at least one memory 13 and the computer program code configured to, with the at least one processor 12, cause the apparatus at least to perform:
receiving at least one first signal comprising an indication of at least one bit of a first System Frame Number, SFN;
determining, based at least in part on the received at least one first signal, at least one value of a reliability metric for the at least one bit of the first SFN;
receiving at least one second signal comprising an indication of at least one bit of a second SFN different than the first SFN;
determining, based at least in part on the received at least one second signal and the determined at least one value of the reliability metric for the at least one bit of the first SFN, at least one value of a reliability metric for the at least one bit of the second SFN.

The above described examples find application as enabling components of: tracking systems, automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things (IoT); Vehicle-to-everything (V2X), virtualized networks; and related software and services.

The apparatus can be provided in an electronic device, for example, a mobile terminal, according to an example of the present disclosure. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus can be provided in a mobile terminal, other types of electronic devices, such as, but not limited to, hand portable electronic devices, wearable computing devices, portable digital assistants (PDAs), pagers, mobile computers, desktop computers, televisions, gaming devices, laptop computers, cameras, video recorders, GPS devices and other types of electronic systems, can readily employ examples of the present disclosure. Furthermore, devices can readily employ examples of the present disclosure regardless of their intent to provide mobility.

FIG. 8, illustrates a computer program 14 conveyed via a delivery mechanism 20. The delivery mechanism 20 can be any suitable delivery mechanism, for example, a machine readable medium, a computer-readable medium, a non-transitory computer-readable storage medium, a computer program product, a memory device, a solid-state memory, a record medium such as a memory card, flash drive, Solid State Drive (SSD), Compact Disc Read-Only Memory (CD-ROM) or a Digital Versatile Disc (DVD) or an article of manufacture that comprises or tangibly embodies the computer program 14. The delivery mechanism can be a signal configured to reliably transfer the computer program. An apparatus can receive, propagate or transmit the computer program as a computer data signal.

In certain examples of the present disclosure, there is provided computer program instructions for causing an apparatus 10, such as a UE 110, to perform at least the following or for causing performing at least the following:
receiving at least one first signal comprising an indication of at least one bit of a first System Frame Number, SFN;
determining, based at least in part on the received at least one first signal, at least one value of a reliability metric for the at least one bit of the first SFN;
receiving at least one second signal comprising an indication of at least one bit of a second SFN different than the first SFN;
determining, based at least in part on the received at least one second signal and the determined at least one value of the reliability metric for the at least one bit of the first SFN, at least one value of a reliability metric for the at least one bit of the second SFN.

References to ‘computer program’, ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ can refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions and
(c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

Although specific terms are employed herein, they are used in a generic and descriptive sense only and not for purposes of limitation.

Features described in the preceding description can be used in combinations other than the combinations explicitly described.

Although functions have been described with reference to certain features, those functions can be performable by other features whether described or not. Although features have been described with reference to certain examples, those features can also be present in other examples whether described or not. Accordingly, features described in relation to one example/aspect of the disclosure can include any or all of the features described in relation to another example/aspect of the disclosure, and vice versa, to the extent that they are not mutually inconsistent.

Although various examples of the present disclosure have been described in the preceding paragraphs, it should be appreciated that modifications to the examples given can be made without departing from the scope of the invention as set out in the claims. For example, whilst examples have been described and formulas/relationships between LSBs of SFNs of successive SS/PBCH block bursts of a set of SS/PBCH block bursts (i.e., immediately following/next SS/PBCH block bursts, namely i^{th} and i+1^{th} bursts), the skilled person would appreciate that equivalent formulas/relationships could be derived for other bursts of the set of bursts, e.g., not least i^{th} and i+2^{th} bursts. Whilst examples have been described with regards to improving the reliability of detection of LSBs of SFNs of an i+1^{th} SS/PBCH block burst based on detection of LSBs of SFNs of an i^{th} SS/PBCH block burst, in some examples, the reliability of detection of LSBs of SFNs of an i^{th} SS/PBCH block burst could be sought to be improved based on detection of LSBs of SFNs of an i+1^{th} SS/PBCH block burst.

The term ‘comprise’ is used in this document with an inclusive not an exclusive meaning. That is any reference to X comprising Y indicates that X can comprise only one Y or can comprise more than one Y. If it is intended to use ‘comprise’ with an exclusive meaning then it will be made clear in the context by referring to “comprising only one . . . ” or by using “consisting”.

In this description, the wording ‘connect’ and ‘communication’ and their derivatives mean operationally connected/in communication. It should be appreciated that any number or combination of intervening components can exist (including no intervening components), i.e., so as to provide direct or indirect connection/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’, ‘can’ or ‘may’ in the text denotes, whether explicitly stated or not, that such features or functions are present in at least the described example, whether described as an example or not, and that they can be, but are not necessarily, present in some or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class.

In this description, references to “a/an/the” [feature, element, component, means . . . ] are to be interpreted as “at least one” [feature, element, component, means . . . ] unless explicitly stated otherwise. That is any reference to X comprising a/the Y indicates that X can comprise only one Y or can comprise more than one Y unless the context clearly indicates the contrary. If it is intended to use ‘a’ or ‘the’ with an exclusive meaning then it will be made clear in the context. In some circumstances the use of ‘at least one’ or ‘one or more’ can be used to emphasise an inclusive meaning but the absence of these terms should not be taken to infer any exclusive meaning.

The presence of a feature (or combination of features) in a claim is a reference to that feature (or combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

In the above description, the apparatus described can alternatively or in addition comprise an apparatus which in some other examples comprises a distributed system of apparatus, for example, a client/server apparatus system. In examples where an apparatus provided forms (or a method is implemented as) a distributed system, each apparatus forming a component and/or part of the system provides (or implements) one or more features which collectively implement an example of the present disclosure. In some examples, an apparatus is re-configured by an entity other than its initial manufacturer to implement an example of the present disclosure by being provided with additional software, for example by a user downloading such software, which when executed causes the apparatus to implement an example of the present disclosure (such implementation being either entirely by the apparatus or as part of a system of apparatus as mentioned hereinabove).

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavouring in the foregoing specification to draw attention to those features of examples of the present disclosure believed to be of particular importance it should be understood that the applicant claims protection in respect of any patentable feature or combination of features hereinbefore referred to and/or shown in the drawings whether or not particular emphasis has been placed thereon.

The examples of the present disclosure and the accompanying claims can be suitably combined in any manner apparent to one of ordinary skill in the art. Separate references to an “example”, “in some examples” and/or the like in the description do not necessarily refer to the same example and are also not mutually exclusive unless so stated and/or except as will be readily apparent to those skilled in the art from the description. For instance, a feature, structure, process, step, action, or the like described in one example may also be included in other examples, but is not necessarily included.

Each and every claim is incorporated as further disclosure into the specification and the claims are embodiment(s) of the present disclosure. Further, while the claims herein are provided as comprising specific dependencies, it is contemplated that any claims can depend from any other claims and that to the extent that any alternative embodiments can result from combining, integrating, and/or omitting features of the various claims and/or changing dependencies of claims, any such alternative embodiments and their equivalents are also within the scope of the disclosure.

1. An apparatus comprising:
at least one processor; and,
at least one memory storing instructions that, when executed by the at least one processor, causes the apparatus at least to perform:
receiving at least one first signal comprising an indication of at least one bit of a first System Frame Number, SFN;
determining, based at least in part on the received at least one first signal, at least one value of a reliability metric for the at least one bit of the first SFN;
receiving at least one second signal comprising an indication of at least one bit of a second SFN different than the first SFN; and,
determining, based at least in part on the received at least one second signal and the determined at least one value of the reliability metric for the at least one bit of the first SFN, at least one value of a reliability metric for the at least one bit of the second SFN,
wherein determining the at least one value of a reliability metric for the at least one bit of the second SFN of the at least one second signal comprises: calculating at least one Log Likelihood Ratio, LLR, for the at least one bit of the second SFN of the at least one second signal, and wherein calculating the at least one LLR for the at least one bit of the second SFN of the at least one second signal is based at least in part on a calculated LLR for the at least one bit of the first SFN of the at least one first signal.

2. The apparatus of claim 1, wherein the apparatus is further caused to:
determine a value of the at least one bit of the second SFN based at least in part on the determined at least one value of the reliability metric for the at least one bit of the second SFN.

3. The apparatus of claim 1, wherein the at least one first and/or the at least one second signal comprises at least one or a plurality selected from a group of:
at least one first and/or second transmission of time information;
at least one first and/or second transmission of one or more bits of the respective first and/or second SFN;
at least one first and/or second transmission of the respective at least one first and/or second SFN;
at least one first and/or second signal carried by a respective at least one first and/or second Physical Broadcast Channel, PBCH;
at least one first and/or second signal received in a respective at least one first and/or second radio frame;
at least one first and/or second signal carried by a respective at least one first and/or second SS/PBCH block;
at least one first and/or second signal carried by an SS/PBCH block of a respective at least one first and/or second SS/PBCH block burst; and
at least one first and/or second signal carried by an SS/PBCH block of a respective at least one first and/or second SS/PBCH block burst of a set of SS/PBCH block bursts transmitted over a pre-determined time interval.

4. The apparatus of claim 1, wherein the at least one bit of the first and/or second SFN is at least one selected from a group of:
one or more bits of a PBCH payload that are expected to vary over a pre-determined time interval;
an n^{th} bit of the respective first and/or second SFN;
some or all of the bits of the respective first and/or second SFN;
at least one Most Significant Bit, MSB, of the respective first and/or second SFN;
at least one Least Significant Bit, LSB, of the respective first and/or second SFN;
a second LSB of the respective first and/or second SFN; and
a third LSB of the respective first and/or second SFN.

5-6. (canceled)

7. The apparatus of claim 1, wherein:
the at least one bit of the first SFN is: a second LSB of the first SFN and a third LSB of the first SFN; and
the at least one bit of the second SFN is: a second LSB of the second SFN and a third LSB of the second SFN.

8. The apparatus of claim 1, wherein determining the at least one value of a reliability metric for the at least one bit of the second SFN is based, at least in part, on a determination that the at least one second signal is received within a pre-determined time interval.

9. The apparatus of claim 8, wherein the pre-determined time interval comprises a time interval during which a majority of bits of a PBCH payload of a SS/PBCH block of a set of SS/PBCH block bursts is expected to remain constant.

10. The apparatus of claim 1, wherein the at least one first signal is received during a first radio frame, and wherein the at least one second signal is received during a second radio frame different to the first.

11. The apparatus of claim 10, wherein the first radio frame directly precedes the second radio frame.

12. The apparatus of claim 10, wherein there are one or more radio frames between the first radio frame and the second radio frame.

13. The apparatus of claim 1, wherein determining the at least one value of a reliability metric for the at least one bit of the first SFN comprises:
calculating:
$${L}_{{a}_{j}^{1}}^{{a}_{posteriori}} = log ( \frac{P ( {y}_{j}^{1} \vert {a}_{j}^{1} = 0 )}{P ( {y}_{j}^{1} \vert {a}_{j}^{1} = 1 )} ) + {L}_{{a}_{j}^{1}}^{{a}_{priori}}$$
where:
a¹ⱼ is a bit of the at least one bit of the first SFN indicated in the at least one first signal in bit position j, wherein bit position j=0 represents the LSB of the first SFN;
Lₐ_{ⱼ}_{¹}^{a}^{ₚₒₛₜₑᵣᵢₒᵣᵢ} is an a-posteriori LLR for the bit aⱼ¹;
yⱼ¹ is the received at least one first signal at bit position j;
P(yⱼ¹|aⱼ¹=0) is a probability of the received at least one first signal, conditioned to the bit at bit position j being equal to 0;
P(yⱼ¹|aⱼ¹=1) is a probability of the received at least one first signal, conditioned to the bit at bit position j being equal to 1;
Lₐ_{ⱼ}_{¹}^{a}^{ₚᵣᵢₒᵣᵢ} is an a-priori LLR for a bit of the first SFN indicated in the at least one first signal in bit position j; and wherein Lₐ_{¹}_{ⱼ}^{a}^{ₚᵣᵢₒᵣᵢ}=0.

14. The apparatus of claim 1, wherein determining the at least one value of a reliability metric for the at least one bit of the second SFN comprises:
calculating:
$${L}_{{a}_{j}^{2}}^{{a}_{posteriori}} = log ( \frac{P ( {y}_{j}^{2} \vert {a}_{j}^{2} = 0 )}{P ( {y}_{j}^{2} \vert {a}_{j}^{2} = 0 )} ) + {L}_{{a}_{j}^{2}}^{{a}_{priori}}$$
where:
aⱼ² is a bit of the at least one bit of the second SFN indicated in the at least one second signal in bit position j, wherein bit position j=0 represents the LSB of the second SFN;
Lₐ_{ⱼ}_{²}^{a}^{ₚₒₛₜₑᵣᵢₒᵣᵢ} is an a-posteriori LLR for the bit aⱼ²;
yⱼ² is the received at least one second signal at bit position j;
P(yⱼ²|aⱼ²=0) is a probability of the received at least one second signal, conditioned to the bit at bit position j being equal to 0;
P(yⱼ²|aⱼ²=1) is a probability of the received at least one second signal, conditioned to the bit at bit position j being equal to 1; and
Lₐ_{ⱼ}_{²}^{a}^{ₚᵣᵢₒᵣᵢ} is an a-priori LLR for a bit of the second SFN indicated in the at least one second signal in bit position j.

15. The apparatus of claim 14, wherein;
for j=1 and at least in the case there is one radio frame between the first radio frame, during which the at least one first signal is received, and the second radio frame, during which the at least one second signal is received;
Lₐ_{²}_{₁}^{a}^{ₚᵣₒᵢᵣᵢ}=−Lₐ_{¹}_{₁}^{a}^{ₚₒₛₜₑᵣᵢₒᵣᵢ}.

16. The apparatus of claim 14, wherein:
for j=2 and at least in the case there is one radio frame between the first radio frame, during which the at least one first signal is received, and the second radio frame, during which the at least one second signal is received;
$${L}_{{{a}^{2}}_{2}}^{{a}_{priori}} = log ( \frac{P ( {{a}^{2}}_{2} = 0 )}{P ( {{a}^{2}}_{2} = 1 )} ) = log ( \frac{P ( {{a}^{1}}_{1} = 0 ) \cdot P ( {{a}^{1}}_{2} = 0 ) + P ( {{a}^{1}}_{1} = 1 ) \cdot P ( {{a}^{1}}_{2} = 1 )}{P ( {{a}^{1}}_{1} = 0 ) \cdot P ( {{a}^{1}}_{2} = 1 ) + P ( {{a}^{1}}_{1} = 1 ) \cdot P ( {{a}^{1}}_{2} = 0 )} ) = log ( \frac{1 + {e}^{( {L}_{{a}_{2}^{1}}^{{a}_{posteriori}} + {L}_{{a}_{1}^{1}}^{{a}_{posteriori}} )}}{{e}^{( {L}_{{a}_{2}^{1}}^{{a}_{posteriori}} )} + {e}^{( {L}_{{a}_{1}^{1}}^{{a}_{posteriori}} )}} )$$

17. The apparatus of claim 14, wherein:
for je≠1 or 2;
$${L}_{{a}_{j}^{2}}^{{a}_{priori}} = log ( \frac{P ( {{a}^{2}}_{j} = 0 )}{P ( {{a}^{2}}_{j} = 1 )} )$$
wherein P(a²ⱼ=0) and P(a²ⱼ=1) are related to P(a¹ₖ=0) and P(a¹ₖ=1), for 0≤k≤j, and
wherein
$$P ( {{a}^{1}}_{k} = 0 ) = \frac{{e}^{{L}_{{{a}^{1}}_{k}}^{{a}_{posteriori}}}}{1 + {e}^{{L}_{{{a}^{1}}_{k}}^{{a}_{posteriori}}}} and P ( {{a}^{1}}_{k} = 1 ) = \frac{1}{1 + {e}^{{L}_{{{a}^{1}}_{k}}^{{a}_{posteriori}}}}$$

18. A chipset or module comprising the apparatus of claim 1.

19. A User Equipment, UE, comprising the chipset or module of claim 18.

20. A method comprising causing, at least in part, actions that result in:
receiving at least one first signal comprising an indication of at least one bit of a first System Frame Number, SFN;
determining, based at least in part on the received at least one first signal, at least one value of a reliability metric for the at least one bit of the first SFN;
receiving at least one second signal comprising an indication of at least one bit of a second SFN different than the first SFN; and,
determining, based at least in part on the received at least one second signal and the determined at least one value of the reliability metric for the at least one bit of the first SFN, at least one value of a reliability metric for the at least one bit of the second SFN,
wherein determining the at least one value of a reliability metric for the at least one bit of the second SFN of the at least one second signal comprises: calculating at least one Log Likelihood Ratio, LLR, for the at least one bit of the second SFN of the at least one second signal, and wherein calculating the at least one LLR for the at least one bit of the second SFN of the at least one second signal is based at least in part on a calculated LLR for the at least one bit of the first SFN of the at least one first signal.

21. A non-transitory computer readable medium comprising program instructions that, when executed by a processor, cause an apparatus to perform at least the following:
receiving at least one first signal comprising an indication of at least one bit of a first System Frame Number, SFN;
determining, based at least in part on the received at least one first signal, at least one value of a reliability metric for the at least one bit of the first SFN;
receiving at least one second signal comprising an indication of at least one bit of a second SFN different than the first SFN; and,
determining, based at least in part on the received at least one second signal and the determined at least one value of the reliability metric for the at least one bit of the first SFN, at least one value of a reliability metric for the at least one bit of the second SFN,
wherein determining the at least one value of a reliability metric for the at least one bit of the second SFN of the at least one second signal comprises: calculating at least one Log Likelihood Ratio, LLR, for the at least one bit of the second SFN of the at least one second signal, and wherein calculating the at least one LLR for the at least one bit of the second SFN of the at least one second signal is based at least in part on a calculated LLR for the at least one bit of the first SFN of the at least one first signal.
